(19) United States
(12) Patent Application Publication
(10) Pub. No.: US 2022/0036394 A1
(43) Pub. Date: Feb. 3, 2022

(54) METHOD OF DETERMINING SUGGESTION MODEL, METHOD OF DETERMINING PRICE OF ITEM, DEVICE, AND MEDIUM

(71) Applicant: Baidu International Technology (Shenzhen) Co., Ltd., Shenzhen (CN)

(72) Inventors: Sihan YONG, Shenzhen (CN); Zhenghua WANG, Shenzhen (CN); Zheyuan LI, Shenzhen (CN)

(21) Appl. No.: 17/500,999

(22) Filed: Oct. 14, 2021

(30) Foreign Application Priority Data
Oct. 16, 2020 (CN) 202011114531.5

(51) Int. Cl. G06Q 30/02

(52) U.S. Cl. CPC G06Q 30/0206; G06Q 30/0283

(57) ABSTRACT

The present disclosure provides a method of determining a suggestion model, and a method of determining a price of an item, which may be applied to a field of big data and a field of intelligent recommendation. A specific implementation includes: acquiring a plurality of sample data containing a historical sales volume of an item; determining a predicted demand value for each sample data of the plurality of sample data; determining, based on the predicted demand value for the each sample data, a relationship between a suggested price and a target parameter by using a suggestion model containing the target parameter, so as to obtain a plurality of relationships for the plurality of sample data; and determining, based on the plurality of relationships, a value of the target parameter by using a preset loss model, so as to obtain the suggestion model.

### CROSS-REFERENCE TO RELATED APPLICATIONS

This application is claims priority to Chinese Application No. 202011114531.5, filed on Oct. 16, 2020, which is incorporated herein by reference in its entirety.

### TECHNICAL FIELD

The present disclosure relates to a field of computer technology, in particular to a field of big data and a field of intelligent recommendation, and more specifically to a method of determining a suggestion model, a method of determining a price of an item, a device, and a medium.

### BACKGROUND

In order to adapt to a market demand, a price of an item needs to change with a dynamic change of the market demand. In a related art, the price of the item is generally set manually according to the market demand. However, an artificial response to the market demand is slow, and the price of the item cannot not be adjusted in real time.

### SUMMARY

According to a first aspect, there is provided a method of determining a suggestion model, including: acquiring a plurality of sample data containing a historical sales volume of an item; determining a predicted demand value for each sample data of the plurality of sample data; determining, based on the predicted demand value for the each sample data, a relationship between a suggested price and a target parameter by using a suggestion model containing the target parameter, so as to obtain a plurality of relationships for the plurality of sample data; and determining, based on the plurality of relationships, a value of the target parameter by using a preset loss model, so as to obtain the suggestion model.

According to a second aspect, there is provided a method of determining a price of an item, including: acquiring the historical data for the item within a preset historical period of time, wherein the historical data contains the historical sales volume of the item; determining a predicted demand value for the historical data; and determining a suggested price of the item by using a predetermined suggestion model, based on the predicted demand value for the historical data, wherein the predetermined suggestion model is obtained by the method of determining the suggestion model described above.

According to a third aspect, there is provided an electronic device, including: at least one processor; and a memory communicatively connected to the at least one processor, wherein the memory stores instructions executable by the at least one processor, and the instructions, when executed by the at least one processor, cause the at least one processor to implement the method of determining the suggestion model described above or the method of determining the price of the item described above.

According to a fourth aspect, there is provided a non-transitory computer-readable storage medium having computer instructions stored thereon, wherein the computer instructions are configured to cause a computer to implement the method of determining the suggestion model described above or the method of determining the price of the item described above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure.

FIG. 1 shows an application scenario diagram of a method and apparatus of determining a suggestion model, a method and apparatus of determining a price of an item, a device and a medium according to the embodiments of the present disclosure.

FIG. 2 shows a schematic flowchart of a method of determining a suggestion model according to the embodiments of the present disclosure.

FIG. 3 shows an operation flowchart of determining a value of a target parameter according to an embodiment of the present disclosure.

FIG. 4 shows a principle diagram of determining the value of the target parameter according to another embodiment of the present disclosure.

FIG. 5 shows a schematic flowchart of a method of determining a price of an item according to the embodiments of the present disclosure.

FIG. 6 shows a block structural diagram of an apparatus of determining a suggestion model according to the embodiments of the present disclosure.

FIG. 7 shows a block structural diagram of an apparatus of determining a price of an item according to the embodiments of the present disclosure. and

FIG. 8 shows a block diagram of an electronic device for implementing the method of determining the suggestion model or the method of determining the price of the item according to the embodiments of the present disclosure.

### DETAILED DESCRIPTION OF EMBODIMENTS

The exemplary embodiments of the present disclosure are described below with reference to the drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

The present disclosure provides a method of determining a suggestion model. The method includes: acquiring a plurality of sample data containing a historical sales volume of an item; determining a predicted demand value for each sample data of the plurality of sample data; determining, based on the predicted demand value for the each sample data, a relationship between a suggested price and a target parameter by using a suggestion model containing the target parameter, so as to obtain a plurality of relationships for the plurality of sample data; and determining, based on the plurality of relationships, a value of the target parameter by using a preset loss model, so as to obtain the suggestion model.

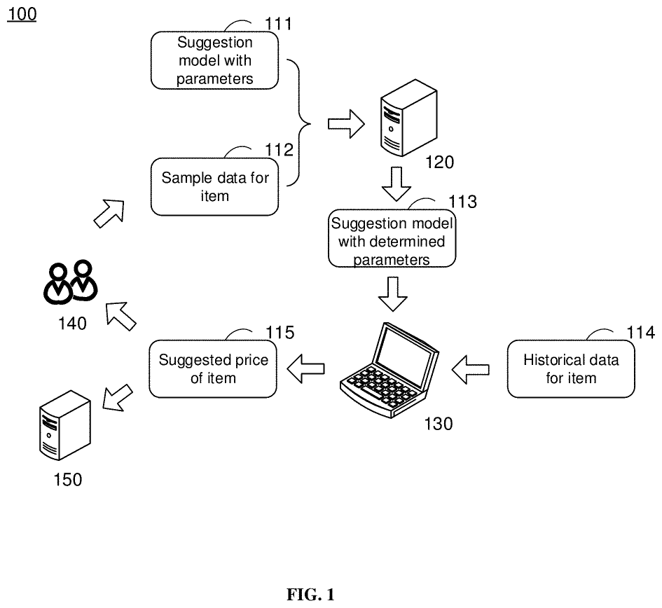

An application scenario of the method and the apparatus provided in the present disclosure will be described below with reference to FIG. 1.

FIG. 1 shows an application scenario diagram of a method and apparatus of determining a suggestion model, a method and apparatus of determining a price of an item, a device and a medium according to the embodiments of the present disclosure.

As shown in FIG. 1, an application scenario 100 of the embodiment may be, for example, a forward payment scenario, in which a suggestion model for suggesting a price is determined and a price suggestion is performed based on the determined suggestion model.

According to the embodiments of the present disclosure, the suggestion model may be pre-set. The suggestion model may, for example, take a historical price of an item, a historical sales volume of the item or a predicted market demand value of the item as an independent variable, and take a suggested price of the item as a dependent variable.

According to the embodiments of the present disclosure, the suggestion model may contain, for example, a parameter with an unknown value. The value of the parameter may be obtained in a following manner. Firstly, a plurality of predicted suggested prices represented by the parameter may be obtained according to a plurality of sample data for the item and the suggestion model containing the parameter. Then, the plurality of predicted suggested prices are compared with an actual historical price of the item, so as to determine the value of the parameter corresponding to a minimum difference between the predicted suggested price and the actual historical price. Exemplarily, as shown in FIG. 1, a method of determining the value of the parameter contained in the suggestion model may be performed, for example, by a first device 120. A suggestion model 111 containing the parameter may be pre-stored in the first device 120, or may be acquired by the first device 120 from other devices such as a database or a server. Sample data 112 for the item may be provided by, for example, an item supplier 140 or an e-commerce company. The first device 120 may obtain a suggestion model 113 with a determined parameter according to the suggestion model 111 with the parameter and the sample data 112 for the item.

Exemplarily, the plurality of sample data 112 for the item may contain information such as a historical price of the item, a historical sales volume of the item, a sales time of the item, and the like. In case of the suggestion model takes the historical price of the item or the historical sales volume of the item as the independent variable, the predicted suggested price represented by the parameter may be obtained by substituting the plurality of sample data 112 for the item into the suggestion model.

Exemplarily, in case of the suggestion model takes the predicted market demand value of the item as the independent variable, the first device 120 may, for example, firstly take the plurality of sample data 112 for the item as an input of a demand prediction model to output a predicted market demand.

Exemplarily, the first device 120 may be, for example, various electronic devices with processing functions, including but not limited to a smart phone, a tablet computer, a laptop computer, a desktop computer, a server, and so on. The server may be, for example, an application server, a server of a distributed system, or a server combined with a blockchain. Exemplarily, the server may also be, for example, a virtual server or a cloud server.

After the suggestion model 113 with the determined parameter is obtained, the suggestion model 113 may be used to determine the suggested price of the item, so as to provide a reference for the item supplier 140 or the e-commerce company to set the price of the item. As shown in FIG. 1, the application scenario 100 of the embodiment may further include a second device 130. The second device 130 is used to acquire, from the historical data 114 for the item, an input of the suggestion model 113 having the determined parameter, and obtain a suggested price 115 of the item from an output of the suggestion model 113 having the determined parameter.

Exemplarily, the second device 130 may be, for example, various electronic devices with processing functions, and the second device 130 may be, for example, a different device from the first device 120. Alternatively, the second device 130 and the first device 120 may be two functional modules in the same apparatus for performing different operations.

Exemplarily, the second device 130 may be, for example, a background server that provides services to an application. The application may be an application installed in a terminal device of the item supplier or a terminal device of the e-commerce company and used to determine the suggested price. In this way, the second device 130 may provide the output suggested price 115 of the item to the terminal device of the item supplier 140 or the terminal device 150 of the e-commerce company.

Exemplarily, the historical data 114 for the item may be obtained, for example, by the second device 130 through interaction with the terminal device of the supplier or the terminal device of the e-commerce company. The historical data 114 for the item may include, for example, the sales volume of the item, the price of the item, and the like within a preset period of time prior to a current time.

In a usage scenario, if the supplier or the e-commerce company needs to set the price of an item A, the supplier or the e-commerce company may provide the historical data for the item A within a first preset period of time to the first device 120. The first device 120 may, for example, divide the historical data within the first preset period of time into historical data within a first sub-period of time and historical data within a second sub-period of time. The historical data within the first sub-period of time may be taken as training sample data, and the historical data within the second sub-period of time may be taken as historical data for predicting the suggested price. Then, the suggestion model may be trained according to the training sample data, so as to obtain the suggestion model with the determined parameter for the item A. The suggestion model having the determined parameter and the historical data for predicting the suggested price are transmitted to the second device 130. The second device 130 may obtain the suggested price of the item A according to the historical data received and the suggestion model. The first sub-period of time is before the second sub-period of time, so as to ensure real-time of the suggested price of the item A. After the parameter of the suggestion model is determined, the supplier or the e-commerce company may further provide latest historical data to the second device 130 in real time and obtain real-time suggested price provided by the second device 130, so as to update the price set for the item A in real time.

It should be noted that the parameter of the suggestion model may have different values according to sample data for different items, so as to ensure the determined suggestion model to be targeted and improve accuracy of the suggested prices of various items.

It should be understood that the method of determining the suggestion model provided by the embodiments of the present disclosure may generally be performed by the first device 120, and the method of determining the price of the item provided by the embodiments of the present disclosure may generally be performed by the second device 130. Accordingly, the apparatus of determining the suggestion model provided by the embodiments of the present disclosure may generally be implemented by the first device 120, and the apparatus of determining the price of the item provided by the embodiments of the present disclosure may generally be implemented by the second device 130. Numbers and types of the first device, the second device and the terminal device in FIG. 1 are merely illustrative. According to implementation needs, there may be any numbers and types of first device, second device and terminal device.

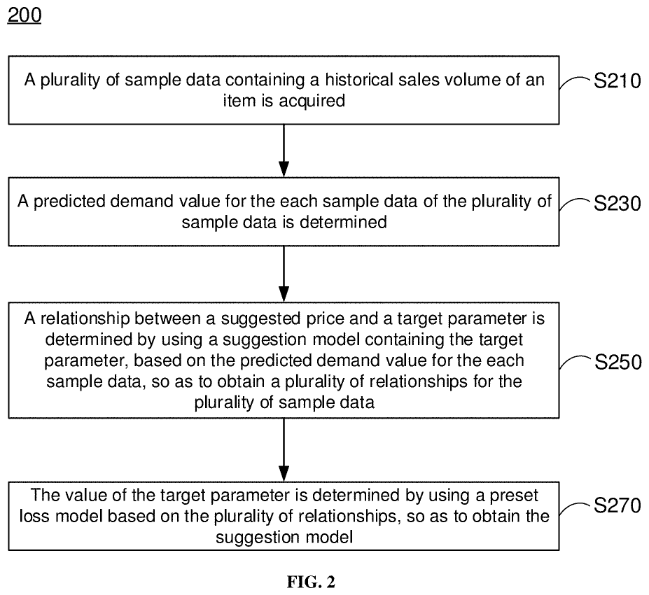

The method of determining the suggestion model according to the embodiments of the present disclosure will be described in detail below with reference to FIG. 2 to FIG. 4 in combination with FIG. 1.

FIG. 2 shows a schematic flowchart of a method of determining a suggestion model according to the embodiments of the present disclosure.

As shown in FIG. 2, a method 200 of determining the suggestion model of the embodiment may include operation S210, operation S230, operation S250 and operation S270.

In the operation S210, a plurality of sample data containing a historical sales volume of an item is acquired.

According to the embodiments of the present disclosure, in the operation S210, for example, historical data for the item within a first preset period of time may be acquired firstly. The historical data contains the historical sales volume of the item. Subsequently, the first preset period of time is divided into a plurality of periodic intervals, and the historical data acquired is divided into a plurality of sample data according to the plurality of periodic intervals. Each historical data corresponds to a periodic interval.

According to the embodiments of the present disclosure, the plurality of sample data may be provided by the supplier or the like in form of a data list as desired in practical. A sample data includes a row of data or a preset number of rows of data in the data list. A row of data corresponds to a periodic interval.

Exemplarily, the historical sales volume in the each sample data may include a plurality of historical sales volumes in adjacent periods of time. For example, historical data for the item in the past 30 days may be acquired. The 30 days are divided into 10 periodic intervals, and a duration of each periodic interval is 3 days. Subsequently, the historical data acquired is divided into 10 sample data, and each sample data contains historical data for each day in three adjacent days.

In the operation S230, a predicted demand value for the each sample data of the plurality of sample data is determined.

According to the embodiments of the present disclosure, in the operation S230, the predicted demand value for the each sample data may be determined according to the historical sales volume contained in the each sample data. The predicted demand value may be a predicted sales volume within a periodic interval subsequent to the period of time corresponding to the historical sales volume. Alternatively, the predicted demand value may also be a predicted market demand probability within a periodic interval subsequent to the period of time corresponding to the historical sales volume. If the each sample data contains the historical sales volume for each day in three adjacent days, the predicted demand value may represent a predicted market demand for a first day following the three adjacent days.

According to the embodiments of the present disclosure, the predicted demand value for the each sample data of the plurality of sample data may be determined by using a pre-trained recurrent neural network model. In the operation S230, the each sample data of the plurality of sample data may be firstly converted into an input vector of the recurrent neural network model, so as to obtain a plurality of input vectors. Then, the plurality of input vectors are input into the recurrent neural network model respectively to output a plurality of predicted demand values for the plurality of sample data.

Exemplarily, a pre-trained Long-Short-Term Memory (LSTM) network model may be used to determine the predicted demand value for the each sample data of the plurality of sample data, so that time information is taken into account in determining the predicted demand value in the operation S230, thereby improving the accuracy of the determined predicted demand value. Accordingly, the each sample data may contain time information for the historical sales volume of the item in addition to the historical sales volume of the item, and the time information may contain date information.

Exemplarily, in addition to the date information, the time information may contain, for example, a period category for the historical sales volume of the item, including a rest day, a weekday, a traditional festival, and the like. Before the period category is input into the long-short-term memory network model, it may be converted into a vector to be used as a portion of the input vector, through a one-hot encoding method for example. Through inputting of the time category, the long-short-term memory network model may learn a special sales volume in a special date, so that the accuracy of the predicted demand value output may be further improved.

According to the embodiments of the present disclosure, a convolutional neural network may be pre-trained. Alternatively, the plurality of predicted demand values may be obtained based on the plurality of sample data while performing a parameter callback according to a difference between a predicted sales volume indicated by the predicted demand value obtained within the periodic interval and an actual sales volume within the periodic interval, so as to improve accuracy of the convolutional neural network.

In the operation S250, a relationship between a suggested price and a target parameter is determined by using a suggestion model containing the target parameter, based on the predicted demand value for the each sample data, so as to obtain a plurality of relationships for the plurality of sample data.

According to the embodiments of the present disclosure, the suggestion model contains the target parameter. The suggestion model takes the predicted demand value as the independent variable and the suggested price as the dependent variable. In this suggestion model, a value of the target parameter is unknown. In the operation S250, the predicted demand value of the each sample data may be assigned to the independent variable of the suggestion model, so as to obtain the relationship between the suggested price and the target parameter. By assigning the predicted demand values of the plurality of sample data sequentially to the independent variable of the suggestion model, a plurality of relationships between the suggested price and the target parameter may be obtained, and each relationship corresponds to a sample data.

Exemplarily, if the suggestion model is represented by P_{sug}=V(θ,q), the relationship between the suggested price obtained and the target parameter may be represented by, for example, P_{sug}=U(θ) where P_{sug} indicates the suggested price, θ indicates the target parameter, and q indicates the predicted demand value.

In the operation S270, the value of the target parameter is determined by using a preset loss model based on the plurality of relationships, so as to obtain the suggestion model.

According to the embodiments of the present disclosure, the preset loss model may be, for example, a square loss function model, which may reflect a sum of squares of the differences between the actual price and the suggested prices. In the operation S270, U (θ) representing the plurality of relationships between the suggested prices and the target parameter as described above may be assigned to the suggested price in the preset loss function. Exemplarily, the preset loss model may be represented by:

$${L}_{loss} = arg {min}_{θ} {\sum }_{i = 1}^{N} ( {P}_{r i} - {P}_{s u g i} )$$

After U (θ) is assigned, the loss function model Lₗₒₛₛ is a function of θ. In the operation S270, a value of θ corresponding to a minimum value of Lₗₒₛₛ may be determined by using a gradient descent algorithm. This value of θ may be taken as the value of the target parameter. It may be understood that the square loss function model described above is only an example of the preset loss model. In other embodiments, for example, an absolute value loss function or a hinge loss function may be used. A specific form of the preset loss model may be set as desired in practical.

According to the embodiments of the present disclosure, after the value of the target parameter is determined, it is introduced into the suggestion model containing the target parameter, so that the suggestion model with only the independent variable having an unknown value is obtained. The suggestion model with the value of the target parameter being introduced may be used to determine the suggested price of the item.

In the embodiments of the present disclosure, the predicted demand value of the item may be firstly obtained according to the sample data, and then the value of the target parameter of the suggestion model may be determined according to the predicted demand values for the plurality of sample data and the preset loss function. In this way, the suggestion model obtained may fit the actual market demand of the item and accurately reflect the relationship between the suggested price of the item and a market factor, so that the accuracy of the suggested price determined by using the suggestion model may be improved.

According to the embodiments of the present disclosure, in addition to the historical sales volume, the sample data obtained in the above operations may contain, for example, historical hot information for the item. Hot information may be, for example, popular movie information, hot news information, hot searching, and the like. The information may be converted through the one-hot encoding method into a vector as a portion of the input vector. Through inputting of the hot information, market popularity may be further taken into account in determining the predicted demand value in the operation S230, so that the accuracy of the output predicted demand value may be further improved. For example, if the item is a peripheral product of a popular movie, the market demand for the amount of the product is large, and thus the predicted demand value is large. If the item is a peripheral product of an unpopular movie, the market demand for the amount of the product is small, and the predicted demand value is small.

According to the embodiments of the present disclosure, in addition to the historical sales volume, the sample data acquired in the above described operations may contain, for example, a historical price of a competitive item for the item within the period of time corresponding to the historical sales volume. The sales volume of the item may be affected by the price of the competitive item in a certain extent. By adding the historical price of the competitive item into the input vector, the accuracy of the predicted demand value may be further improved. Exemplarily, in addition to the historical price of the competitive item, the sample data may contain a similarity between the competitive item and the item, so that when determining the predicted demand value by the convolution neural network, a weight representing an influence of the historical price of the competitive item on the predicted demand value may be determined according to the similarity.

According to the embodiments of the present disclosure, by acquiring the hot information, the historical price of the competitive item and the similarity between the competitive item and the item while acquiring the historical sales volume, it is possible to reflect a relationship between the demand for the item and other market motivations except for the item by the recurrent neural network model for determining the predicted demand value. In this way, the predicted demand value may be determined more accurately, and the accuracy of the suggestion model which is subsequently determined may be ensured.

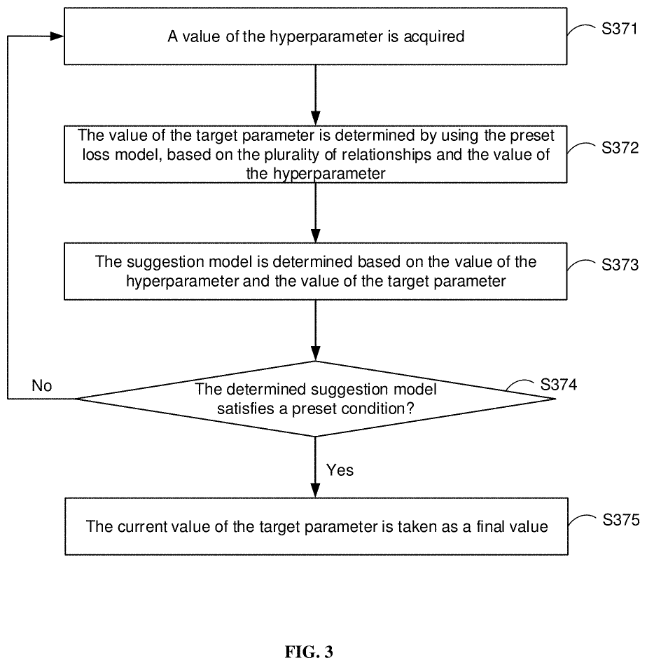

FIG. 3 shows an operation flowchart of determining the value of the target parameter by using the preset loss model according to the embodiments of the present disclosure.

According to the embodiments of the present disclosure, in addition to the target parameter with an unknown value, the suggestion model described above may contain, for example, a hyperparameter, so that the suggestion model may reflect a more complex relationship between the suggested price and the predicted demand value, improving the accuracy of the determined suggestion model.

According to this embodiment, in a case that the suggestion model contains the hyperparameter, the hyperparameter may be optimized when the value of the target parameter is determined to determine the suggestion model, so as to improve learning performance and learning effect of the suggestion model. As shown in FIG. 3, the operation of determining the value of the target parameter by using the preset loss model in this embodiment may include, for example, performing operation S371 to operation S374 cyclically until the determined suggestion model satisfies a preset condition, and performing operation S375 in case of the determined suggestion model satisfies the preset condition.

In the operation S371, a value of the hyperparameter is acquired.

According to the embodiments of the present disclosure, the value of the hyperparameter, for example, may be manually input so that the first device may acquire the value of the hyperparameter in response to the manual input. At an end of each cycle, the value of the hyperparameter may be adjusted manually according to the determined suggestion model, so that the suggestion model obtained in a next cycle may be more accurate.

According to the embodiments of the present disclosure, for example, a group of hyperparameter values may be pre-selected by a learning machine. In the operation S371, a hyperparameter value may be acquired from the group of hyperparameter values in an order.

According to the embodiments of the present disclosure, in the operation S371, the value of the hyperparameter may be acquired by using a grid search technology. The grid search technology is essentially an exhaustive method, in which a small finite set of numbers may be firstly selected manually, and then the first device traverse the values in the set of numbers through the exhaustive method.

According to the embodiments of the present disclosure, in the case that the suggestion model further contains the hyperparameter, the plurality of relationships determined above may represent not only the relationship between the suggested price and the target parameter, but also a relationship between the suggested price and the hyperparameter. Accordingly, the suggestion model may be represented, for example, by P_{sug}=W (θ, φ), where φ is the hyperparameter.

In the operation S372, the value of the target parameter is determined by using the preset loss model based on the plurality of relationships and the value of the hyperparameter.

According to the embodiments of the present disclosure, in the operation S372, W (θ, φ) representing the plurality of relationships between the suggested prices and the target parameter may be assigned to the suggested price in the preset loss function, and the value of the hyperparameter may be assigned to φ in W (θ, φ). In this case, the preset loss function is a function of θ. The value of θ at which the value of the present loss function is minimum may be determined by using a gradient descent algorithm or a reverse gradient algorithm, and may be taken as the value of the target parameter.

In the operation S373, the suggestion model is determined based on the value of the hyperparameter and the value of the target parameter.

After the value of the hyperparameter is obtained and the value of the target parameter is determined, the value of the hyperparameter and the value of the target parameter may be introduced into the suggestion model containing the target parameter and the hyperparameter, so that the suggestion model with only the independent variable having an unknown value is obtained.

In the operation S374, it is determined whether the determined suggestion model satisfies a preset condition.

According to the embodiments of the present disclosure, the preset condition may include, for example, a condition in which a difference between two values of the target parameter determined in two adjacent cycles is less than a first preset difference. If the two values of the target parameter determined in the two adjacent cycles are close to each other, it may be determined that the value of the target parameter of the suggestion model is close to an optimal value, and the current value of the target parameter is determined as an accurate value. Accordingly, it is determined that the accuracy of the suggestion model in which the value of the target parameter is introduced may meet the demand. The first preset difference may be set as desired in practical, and is not limited in the present disclosure.

According to the embodiments of the present disclosure, the preset condition may include, for example, a condition in which a difference between the suggested prices determined by the suggestion model determined in two adjacent cycles is less than a second preset difference. According to the embodiment, test data may be acquired after the suggestion model is obtained in the operation S373. The test data is similar to the sample data. The predicted demand value may be obtained according to the test data and may be introduced into the suggestion model, so as to obtain the suggested price for the test data. For the same test data, if a difference between the two suggested prices obtained by using the suggestion models determined in two adjacent cycles is less than the second preset difference, it may be determined that the suggestion model obtained in a later cycle of the two adjacent cycles satisfies the preset condition. The second preset difference may be set as desired in practical, and is not limited in the present disclosure.

According to the embodiments of the present disclosure, the preset condition may include, for example, a condition in which a determined minimum value of the preset loss model is less than a third preset value. According to the embodiment, after the value of the target parameter is obtained in the operation S372, it may be determined whether the minimum value of the preset loss model determined based on the value of the target parameter is less than a preset value. If the difference is less than the preset value, it is determined that the suggestion model satisfies the preset condition. The preset value may be set as desired in practical, and is not limited in the present disclosure. Exemplarily, the third preset difference may be 10⁻ⁿ, where n is a positive integer, and a value of n may be set as desired in practical.

If it is determined in the operation S374 that the determined suggestion model satisfies the preset condition, the operation S375 is performed to take the current value of the target parameter as a final value.

If it is determined in the operation S374 that the suggestion model obtained does not satisfy the preset condition, the process returns to the operation S371 to re-acquire the value of the hyperparameter and re-determine the suggestion model.

According to the embodiments of the present disclosure, by adding the hyperparameter to the suggestion model containing the target parameter, the suggestion model obtained finally may reflect the relationship between the suggested price and the market motivation more accurately, so as to improve the accuracy of the suggested price determined by using the suggestion model.

According to the embodiments of the present disclosure, the suggestion model may further contain, for example, a predetermined price P, which may be manually set. The above described V (θ, q) containing the predicted demand value and the target parameter may be taken as a regulation factor to adjust the manually set predetermined price. For example, the suggestion model may be represented by following equation:

P_{sug}=P*V(θ,q)

Exemplarily, in order to better reflect the complex relationship between the suggested price and the market demand, relationship between the regulation factor V and the predicted demand value q, for example, may be nonlinear. For example, the relationship between V and q may be represented as follows. It may be understood that the nonlinear relationship between V and q is only an example to facilitate the understanding of the present disclosure, and is not limited in the present disclosure.

V_{θ}∝θ*(q−θ).

According to the embodiments of the present disclosure, in the case that the suggestion model contains the hyperparameter, the suggestion model may be represented as:

P_{sug}=P*W(θ,φ,q).

According to the embodiments of the present disclosure, in determining the value of the target parameter, for example an average value of the historical sales volumes of the item may be further taken into account, so that the suggestion model determined finally may reflect the relationship between the suggested price and the market demand more accurately.

Exemplarily, in the operation of determining the value of the target parameter by using the preset loss model described above, an average value of the plurality of historical sales volumes contained in the plurality of sample data may be determined firstly. Then, an association relationship between the value of the preset loss model and the plurality of relationships may be determined based on the average value and the plurality of historical sales volumes. Finally, the value of the target parameter corresponding to the minimum value of the preset loss model may be determined by using a reverse gradient algorithm.

Exemplarily, if the historical sales volume in a sample data of the plurality of sample data is significantly higher than the historical sales volume, a weight of the suggested price determined according to the relationship for this sample data may be decreased in determining the value of the preset loss model, so as to ensure stability of the suggestion model and make the suggestion model applicable to a price prediction over a longer period of time. Accordingly, when calculating the sum of squares of the differences between the suggested prices and the actual price by using the preset loss model, for example, a weight may be assigned to the sum of squares. The weight is determined according to a difference between the historical sales volume in the sample data and the average value. The determining the association relationship between the value of the preset loss model and the plurality of relationships based on the average value and the plurality of historical sales volumes may include: assigning, if the difference between a sample data and the average value is large, a small weight to the sum of squares obtained based on the suggested price for the sample data in the preset loss model.

FIG. 4 shows a principle diagram of determining the value of the target parameter by using the preset loss model according to another embodiment of the present disclosure.

According to the embodiments of the present disclosure, in determining the value of the preset loss model, a preset price upper limit and a preset price lower limit, for example, may be further taken into account. In this way, the suggested price determined according to the suggestion model may be limited between the preset price upper limit and the preset price lower limit, so that the suggested price may not be excessive low to cause loss to the supplier, and may not be excessive high to make the item unsalable. The preset price upper limit and the preset price lower limit may be set as desired in practical, e.g. according to a cost price of the item and a price of the competitive item, and the present disclosure is not limited thereto.

Exemplarily, the preset loss model may contain two portions, i.e. a difference between the preset price upper limit and the suggested price represented by the target parameter, and a difference between the suggested price represented by the target parameter and the preset price lower limit. Accordingly, the value of the preset loss model is a sum of a first value and a second value. The first value indicates the difference between the preset price upper limit and the suggested price represented by the target parameter, and the second value indicates the difference between the suggested price represented by the target parameter and the preset price lower limit.

Exemplarily, in determining the association relationship between the value of the preset loss model and the plurality of relationships based on the average value and the plurality of historical sales volumes, for a first sample data of the plurality of sample data that contains a historical sales volume greater than or equal to the average value, the association relationship between the value of the preset loss model and a first relationship for the first sample data may be determined. Under the association relationship, the first value is determined according to a first difference between the preset price upper limit and the suggested price determined based on the first relationship. For a second sample data of the plurality of sample data that contains a historical sales volume less than the average value, the association relationship between the value of the preset loss model and a second relationship for the second sample data may be determined. Under the association relationship, the second value is determined according to a second difference between the suggested price determined based on the second relationship and the preset price upper limit. This is because that, when the historical sales volume in the sample data is greater than or equal to the average value, it is generally considered that the price of the item may be appropriately increased to improve profit of the supplier, and when the historical sales volume in the sample data is less than the average value, it is generally considered that the price of the item may be appropriately reduced to achieve a sales target.

Exemplarily, as shown in a principle diagram 400 in FIG. 4, prior to determining the value of the target parameter by using the preset loss model, a sales satisfaction line 410, for example, may be determined according to the historical sales volume of the item, so as to determine the association relationship between the value of the preset loss model and the plurality of relationships. The sales satisfaction line 410 is an average line of the historical sales volumes of the item within a plurality of periodic intervals included in the second preset period of time prior to the current time.

Exemplarily, the sales satisfaction line 410 may be obtained by determining the average value of the plurality of historical sales volumes contained in the plurality of sample data acquired previously, taking the average value as a value of an S-axis in an S-t coordinate system, and drawing a line parallel to a t-axis. The S-axis represents the sales volume, and the t-axis represents time.

After the sales satisfaction line is obtained, the plurality of sample data 420 may be classified into positive sample data 421 and negative sample data 422 according to whether the historical sales volume in the plurality of sample data is lower than the sales satisfaction line 410. The positive sample data 421 is the sample data containing the historical sales volume not lower than the sales satisfaction line 410, and the negative sample data 422 is the sample data containing the historical sales volume lower than the sales satisfaction line 410. Subsequently, a first relationship 431 for the positive sample data 421 and a second relationship 432 for the negative sample data 422 may be obtained by the above operations of determining the predicted demand value and determining the relationship between the suggested price and the target parameter. Then, the suggested price determined based on the first relationship 431 and represented by the target parameter, the preset price upper limit, the suggested price determined based on the second relationship 432 and represented by the target parameter, and the preset price lower limit are introduced into the following preset loss model. In the preset loss model, l is the preset price upper limit, and u is the preset price lower limit. The suggested price determined based on the first relationship 431 and represented by the target parameter is assigned to P_{sug} in a first portion of the following equation, and the suggested price determined based on the second relationship 432 and represented by the target parameter is assigned to P_{sug} in a second portion of the following equation.

$${L}_{loss} = arg {min}_{θ} {\sum }_{i = 1}^{N} ( l - {P}_{s u g i} ) + ( {P}_{s u g i} - u )$$

In determining the value of the preset loss model, a first value 451 is determined according to a difference between a preset price upper limit 441 and the suggested price, which is determined based on the first relationship 431 and represented by the target parameter, and a second value 452 is determined according to a difference between the suggested price, which is determined by the second relationship 432 and represented by the target parameter, and a preset price lower limit 442. Finally, all the first values and all the second values are added to obtain a value 450 of the preset loss model represented by the target parameter. For example, in a case of 10 sample data including 6 positive sample data and 4 negative sample data, 6 first values and 4 second values may be obtained according to the loss model described above, and the 6 first values and the 4 second values may be added finally to obtain the value of the loss model.

According to the embodiments of the present disclosure, the first difference and the second difference may be, for example, an absolute difference, so that the value of the loss model may more accurately reflect a distance between the suggested price and the preset price upper limit as well as a distance between the suggested price and the preset price lower limit.

According to the embodiments of the present disclosure, the determining the first value according to the first difference between the preset price upper limit and the suggested price determined based on the first relationship may include: determining the first value to be a greater one of zero and the first difference. The determining the second value according to the second difference between the suggested price determined based on the second relationship and the preset price lower limit may include: determining the second value to be a greater one of zero and the second difference. Accordingly, the preset loss model may be represented as:

$${L}_{loss} = arg {min}_{θ} {\sum }_{i = 1}^{N} max ( 0 , l - {P}_{s u g i} ) + max ( 0 , {P}_{s u g i} - u ) .$$

In the present disclosure, the first value is set to zero when the first difference value is negative, and the second value is set to zero when the second difference value is negative, so as to avoid an influence of an excessive high or excessive low suggested price with high degree of certainty on the value of the loss function, so that the suggested price finally determined by the suggestion model may meet the market demand to a greater extent.

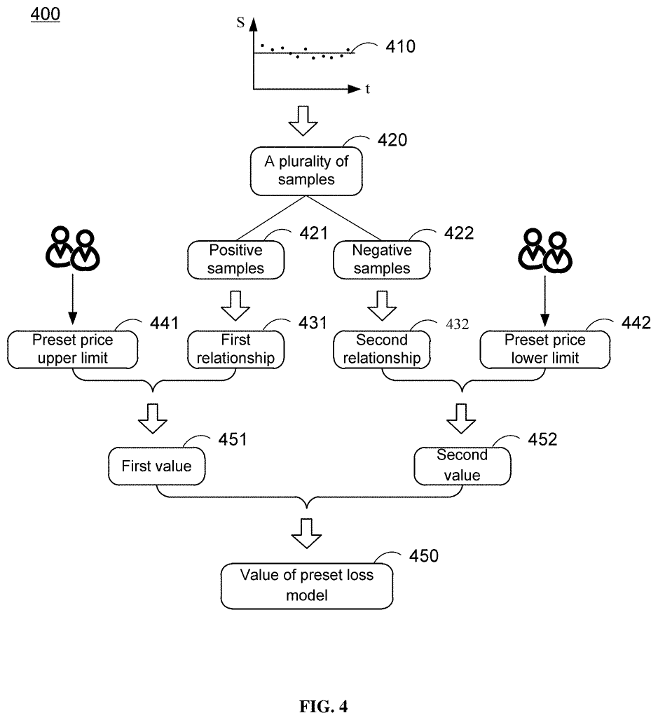

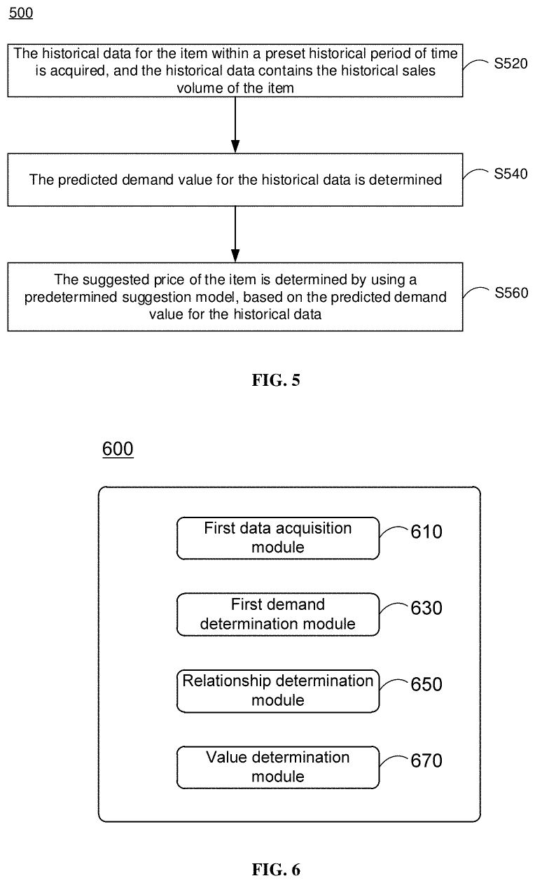

The suggestion model with the determined value of parameters may be used to suggest a price according to the historical data of the item. A method of determining a price of the item provided by the present disclosure will be described in detail below with reference to FIG. 5.

FIG. 5 shows a schematic flowchart of the method of determining the price of the item according to the embodiments of the present disclosure.

As shown in FIG. 5, a method 500 of determining the price of the item according to this embodiment may include operation S510, operation S540 and operation S560.

In the operation S520, the historical data for the item within a preset historical period of time is acquired. The historical data contains the historical sales volume of the item.

According to the embodiments of the present disclosure, the historical data is similar to the sample data described above, with a difference that the historical data acquired in the operation S520 is the historical data which is acquired in real time within the preset number of periodic intervals prior to the current time, while the sample data described above is not required to be real-time data. An amount of the historical data acquired in the operation S520 is equal to that of each sample data. The preset historical period of time includes the preset number of periodic intervals. A length of the periodic interval and the preset number may be set as desired in practical, which is not limited in the present disclosure. Exemplarily, the data within a periodic interval is spliced into one data to be acquired.

Exemplarily, the historical data for the item within the preset historical period of time may further contain at least one of a historical hot information for the item, a historical price of the competitive item for the item, and a time information for the historical sales volume of the item. The information is similar to the corresponding information described above and will not be repeated here.

In the operation S540, the predicted demand value for the historical data is determined.

According to the embodiments of the present disclosure, in the operation S540, the historical data acquired in the operation S520 may be firstly converted into an input of a convolution neural network model, and then the predicted demand value is output. The predicted demand value may reflect the market demand of the item in a next periodic interval. The operation S540 is similar to the above operation of determining the predicted demand value for the sample data, which will not be repeated here.

Exemplarily, when the data within a periodic interval is acquired in the form of one data, a plurality of vectors, for example, may be obtained by converting the acquired historical data. By splicing the plurality of vectors in a chronological order, the input vector may be obtained.

In the operation S560, the suggested price of the item is determined by using a predetermined suggestion model, based on the predicted demand value for the historical data.

According to the embodiments of the present disclosure, in the operation S560, the predicted demand value for the historical data is assigned to an independent variable in the predetermined suggestion model, so that a value of a dependent variable in the suggestion model is obtained and taken as the suggested price of the item.

According to the embodiments of the present disclosure, the suggestion model used in the operation S560 is determined by the method of determining the suggestion model described above. Therefore, it may be ensured that the determined suggested price may meet the market demand well and provide a precise reference for the supplier to determine the price of the item.

FIG. 6 shows a block structural diagram of an apparatus of determining a suggestion model according to some embodiments of the present disclosure.

As shown in FIG. 6, an apparatus 600 of determining the suggestion model of the embodiment may include a first data acquisition module 610, a first demand determination module 630, a relationship determination module 650, and a value determination module 670.

The first data acquisition module 610 is used to acquire a plurality of sample data containing a historical sales volume of an item. In an embodiment, the first data acquisition module 610 may be used to perform the operation S210 described above, which will not be repeated here.

The first demand determination module 630 is used to determine a predicted demand value for each sample data of the plurality of sample data. In an embodiment, the first demand determination module 630 may be used to perform the operation S230 described above, which will not be repeated here.

The relationship determination module 650 is used to determine, based on the predicted demand value for the each sample data, a relationship between a suggested price and a target parameter by using a suggestion model containing the target parameter, so as to obtain a plurality of relationships for the plurality of sample data. In an embodiment, the relationship determination module 650 may be used to perform the operation S250 described above, which will not be repeated here.

The value determination module 670 is used to determine, based on the plurality of relationships, a value of the target parameter by using a preset loss model, so as to obtain the suggestion model. In an embodiment, the value determination module 670 may be used to perform the operation S270 described above, which will not be repeated here.

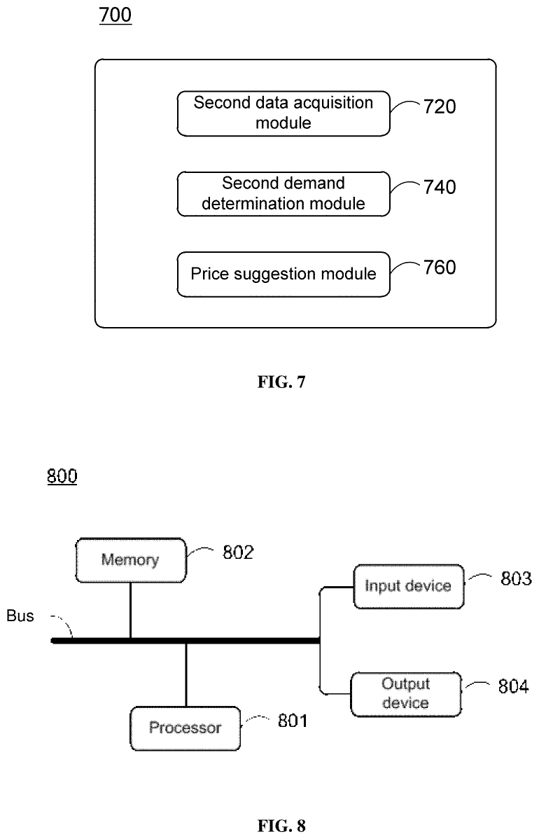

FIG. 7 shows a block structural diagram of an apparatus of determining a price of an item according to some embodiments of the present disclosure.

As shown in FIG. 7, an apparatus 700 of determining the price of the item of the embodiment may include a second data acquisition module 720, a second demand determination module 740, and a price suggestion module 760.

The second data acquisition module 720 is used to acquire the historical data for the item within a preset historical period of time. The historical data contains the historical sales volume of the item. In an embodiment, the second data acquisition module 720 may be used to perform the operation S520 described above, which will not be repeated here.

The second demand determination module 740 is used to determine a predicted demand value for the historical data. In an embodiment, the second demand determination module 740 may be used to perform the operation S540 described above, which will not be repeated here.

The price suggestion module 760 is used to determine the suggested price of the item by using a predetermined suggestion model, based on the predicted demand value for the historical data. In an embodiment, the price suggestion module 760 may be used to perform the operation S560 described above, which will not be repeated here.

Collecting, storing, using, processing, transmitting, providing, and disclosing etc. of the personal information of the user involved in the present disclosure all comply with the relevant laws and regulations, and do not violate the public order and morals.

According to the embodiments of the present disclosure, the present disclosure further provides an electronic device and a readable storage medium.

FIG. 8 shows a block diagram of an electronic device for implementing the method of determining the suggestion model or the method of determining the price of the item according to the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 may include one or more processors 801, a memory 802, and interface(s) for connecting various components, including high-speed interface(s) and low-speed interface(s). The various components are connected to each other by using different buses, and may be installed on a common motherboard or installed in other manners as required. The processor may process instructions executed in the electronic device, including instructions stored in or on the memory to display graphical information of GUI (Graphical User Interface) on an external input/output device (such as a display device coupled to an interface). In other embodiments, a plurality of processors and/or a plurality of buses may be used with a plurality of memories, if necessary. Similarly, a plurality of electronic devices may be connected in such a manner that each device providing a part of necessary operations (for example, as a server array, a group of blade servers, or a multi-processor system). In FIG. 8, a processor 801 is illustrated by way of example.

The memory 802 is a non-transitory computer-readable storage medium provided by the present disclosure. The memory stores instructions executable by at least one processor, to cause the at least one processor to perform the method of determining the suggestion model or the method of determining the price of the item provided in the present disclosure. The non-transitory computer-readable storage medium of the present disclosure stores computer instructions for allowing a computer to perform the method of determining the suggestion model or the method of determining the price of the item provided in the present disclosure.

The memory 802, as a non-transitory computer-readable storage medium, may be used to store non-transitory software programs, non-transitory computer-executable programs and modules, such as program instructions/modules corresponding to the method of determining the suggestion model or the method of determining the price of the item in the embodiments of the present disclosure (for example, the first data acquisition module 610, the first demand determination module 630, the relationship determination module 650 and the value determination module 670 shown in FIG. 6, or the second data acquisition module 720, the second demand determination module 740 and the price suggestion module 760 shown in FIG. 7). The processor 801 executes various functional applications and data processing of the server by executing the non-transient software programs, instructions and modules stored in the memory Y02, thereby implementing the method of determining the suggestion model or the method of determining the price of the item in the embodiments of the method mentioned above.

The memory 802 may include a program storage area and a data storage area. The program storage area may store an operating system and an application program required by at least one function. The data storage area may store data etc. generated by using the electronic device according to the method of determining the suggestion model or the method of determining the price of the item. In addition, the memory 802 may include a high-speed random access memory, and may further include a non-transitory memory, such as at least one magnetic disk storage device, a flash memory device, or other non-transitory solid-state storage devices. In some embodiments, the memory 802 may optionally include a memory provided remotely with respect to the processor 801, and such remote memory may be connected through a network to the electronic device for the method of determining the suggestion model or the method of determining the price of the item. Examples of the above-mentioned network include, but are not limited to the Internet, intranet, local area network, mobile communication network, and combination thereof.

The electronic device for implementing the method of determining the suggestion model or the method of determining the price of the item may further include an input device 803 and an output device 804. The processor 801, the memory 802, the input device 803 and the output device 804 may be connected by a bus or in other manners. In FIG. 8, the connection by a bus is illustrated by way of example.

The input device 803 may receive input information of numbers or character, and generate key input signals related to user settings and function control of the electronic device for implementing the method of determining the suggestion model or the method of determining the price of the item, such as a touch screen, a keypad, a mouse, a track pad, a touchpad, a pointing stick, one or more mouse buttons, a trackball, a joystick, and so on. The output device 804 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an application specific integrated circuit (ASIC), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

These computing programs (also referred as programs, software, software applications, or codes) include machine instructions for a programmable processor, and may be implemented using high-level programming languages, object-oriented programming languages, and/or assembly/machine languages. As used herein, the terms “machine-readable medium” and “computer-readable medium” refer to any computer program product, apparatus and/or device (for example, magnetic disk, optical disk, memory, programmable logic device (PLD)) for providing machine instructions and/or data to a programmable processor, including a machine-readable medium for receiving machine instructions as machine-readable signals. The term “machine-readable signal” refers to any signal for providing machine instructions and/or data to a programmable processor.

In order to provide interaction with the user, the systems and technologies described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server in combination with block chains.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the protection scope of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of determining a suggestion model, comprising:
acquiring a plurality of sample data containing a historical sales volume of an item;
determining a predicted demand value for each sample data of the plurality of sample data;
determining, based on the predicted demand value for the each sample data, a relationship between a suggested price and a target parameter by using a suggestion model containing the target parameter, so as to obtain a plurality of relationships for the plurality of sample data; and
determining, based on the plurality of relationships, a value of the target parameter by using a preset loss model, so as to obtain the suggestion model.

2. The method of claim 1, wherein the suggestion model further contains a hyperparameter; the determining a value of the target parameter by using a preset loss model comprises circularly performing, until the determined suggestion model satisfies a preset condition, operations of:
acquiring a value of the hyperparameter;
determining the value of the target parameter by using the preset loss model, based on the plurality of relationships and the value of the hyperparameter; and
determining the suggestion model based on the value of the hyperparameter and the value of the target parameter.

3. The method of claim 1, wherein the determining a value of the target parameter by using a preset loss model comprises:
determining an average value of a plurality of historical sales volumes contained in the plurality of sample data;
determining an association relationship between a value of the preset loss model and the plurality of relationships, based on the average value and the plurality of historical sales volumes; and
determining, based on the association relationship, a value of the target parameter corresponding to a minimum value of the preset loss model, by using a reverse gradient algorithm.

4. The method of claim 2, wherein the determining a value of the target parameter by using a preset loss model comprises:
determining an average value of a plurality of historical sales volumes contained in the plurality of sample data;
determining an association relationship between a value of the preset loss model and the plurality of relationships, based on the average value and the plurality of historical sales volumes; and
determining, based on the association relationship, a value of the target parameter corresponding to a minimum value of the preset loss model, by using a reverse gradient algorithm.

5. The method of claim 3, wherein the value of the preset loss model is a sum of a first value and a second value; and the determining a relationship between a suggested price and a target parameter by using a suggestion model containing the target parameter comprises:
determining, for a first sample data of the plurality of sample data, an association relationship between the value of the preset loss model and a first relationship for the first sample data, such that the first value is determined according to a first difference between a preset price upper limit and the suggested price determined based on the first relationship, wherein the first sample data contains a historical sales volume greater than or equal to the average value; and
determining, for a second sample data of the plurality of sample data, an association relationship between the value of the preset loss model and a second relationship for the second sample data, such that the second value is determined according to a second difference between the suggested price determined based on the second relationship and a preset price lower limit, wherein the second sample data contains a historical sales volume less than the average value.

6. The method of claim 5, wherein:
determining the first value according to a first difference between a preset price upper limit and the suggested price determined based on the first relationship comprises: determining the first value to be a greater one of zero and the first difference; and
determining the second value according to a second difference between the suggested price determined based on the second relationship and a preset price lower limit comprises: determining the second value to be a greater value of zero and the second difference.

7. The method of claim 1, wherein the suggestion model is represented by:
P_{sug}=P*V(θ,q)
where P_{sug} indicates the suggested price, P indicates a predetermined nominal price, V (θ, q) indicates a regulation factor, θ indicates the target parameter, and q indicates the predicted demand value; wherein a relationship between the regulation factor V and the predicted demand value q is nonlinear.

8. The method of claim 2, wherein the suggestion model is represented by:
P_{sug}=P*V(θ,q)
where P_{sug} indicates the suggested price, P indicates a predetermined nominal price, V (θ, q) indicates a regulation factor, θ indicates the target parameter, and q indicates the predicted demand value; wherein a relationship between the regulation factor V and the predicted demand value q is nonlinear.

9. The method of claim 1, wherein the plurality of sample data further contain at least one of a historical hot information for the item, a historical price of a competitive item for the item, and a time information for the historical sales volume of the item.

10. The method of claim 2, wherein the plurality of sample data further contain at least one of a historical hot information for the item, a historical price of a competitive item for the item, and a time information for the historical sales volume of the item.

11. The method of claim 2, wherein the acquiring a value of the hyperparameter comprises: acquiring the value of the hyperparameter by using a grid search technology.

12. A method of determining a price of an item, comprising:
acquiring historical data for an item within a preset historical period of time, wherein the historical data contains a historical sales volume of the item;
determining a predicted demand value for the historical data; and
determining a suggested price of the item by using a predetermined suggestion model, based on the predicted demand value for the historical data, wherein the predetermined suggestion model is obtained by the method of determining the suggestion model according to claim 1.

13. The method of claim 12, wherein the historical data further contains at least one of a historical hot information for the item, a historical price of a competitive item for the item, and a time information for the historical sales volume of the item.

14. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

15. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 12.

16. A non-transitory computer-readable storage medium having computer instructions stored thereon, wherein the computer instructions are configured to cause a computer to implement the method of claim 1.

17. A non-transitory computer-readable storage medium having computer instructions stored thereon, wherein the computer instructions are configured to cause a computer to implement the method of claim 12.
